(19) United States
(12) Patent Application Publication
(10) Pub. No.: US 2019/0129090 A1
(43) Pub. Date: May 2, 2019

(54) BACKLIGHT MODULE, MOLD FRAME OF A BACKLIGHT MODULE AND DISPLAY DEVICE

(71) Applicants: BOE Technology Group Co., Ltd., Beijing (CN); Hefei BOE Optoelectronics Technology Co., Ltd., Hefei, Anhui (CN)

(72) Inventors: Rubo YING, Beijing (CN); Chengxu MA, Beijing (CN); Zhuhua NIE, Beijing (CN)

(21) Appl. No.: 16/091,412

(22) PCT Filed: Mar. 20, 2018
(86) PCT No.: PCT/CN2018/079587

§ 371 Date: Oct. 4, 2018

(30) Foreign Application Priority Data
Mar. 27, 2017 (CN) 201720306164.6

(51) Int. Cl. F21V 8/00

(52) U.S. Cl. CPC G02B 6/0088

(57) ABSTRACT

The disclosure discloses a backlight module, a mold frame of a backlight module and a display device. The backlight module includes a metal back panel and a mold frame located at an inner side of the metal back panel, where the mold frame includes a frame body and a magnetic layer molded on at least one surface of a side of the frame body facing the metal back panel, and the mold frame is fixedly connected with the metal back panel via the magnetic layer.

This application is a National Stage of International Application No. PCT/CN2018/079587, filed Mar. 20, 2018, which claims priority to Chinese Patent Application No. 201720306164.6, filed Mar. 27, 2017, both of which are hereby incorporated by reference in their entireties.

### TECHNICAL FIELD

This disclosure relates to the field of display technologies and particularly to a backlight module, a mold frame of a backlight module and a display device.

### BACKGROUND

A liquid crystal display has the advantages of small volume, low power consumption, low radiation and the like, and has been widely used in the computer display, laptop, mobile phone, liquid crystal television and other devices. Since a display panel of the liquid crystal display itself does not emit light, a backlight module is needed to provide a light source for the display panel so as to achieve the display effect. At present, the main components constituting the backlight module include a light emitting element, a reflection layer, a light guide plate, an optical film layer, a mold frame, a back panel and so on, where the mold frame is used to connect or locate the other components in the backlight module.

In the prior art, the mold frame and the back panel are generally connected by engaging of a hook and a bayonet or connected by a double-sided adhesive tape. And both of the connection modes of the mold frame and the back panel described above have some disadvantages. For example, when the mold frame and the back panel are connected by engaging, the hook arranged on the mold frame is easy to produce scraps and cause a foreign body defect of the backlight module. In a test of environmental reliability of the backlight module, the mold frame is easy to deform under the high or low temperature, causing a detachment of the engaging of the mold frame and the back panel, and in a maintenance and rework process, the hook of the mold frame is easy to break and deform. When the double-sided adhesive tape is used for fixing the mold frame and the back panel, it is easy to cause a separation or misalignment of the mold frame and the back panel in an assembly process, and glue removing of the double-sided adhesive tape is easy to cause a scrapping of the glue frame or the back panel in the maintenance and rework process. Therefore, the assembly stability of the backlight module in the prior art is relatively poor and the subsequent maintenance is relatively troublesome.

### SUMMARY

The disclosure provides a backlight module, which includes a metal back panel and a mold frame located at an inner side of the metal back panel, where the mold frame includes: a frame body and a magnetic layer molded on at least one surface of a side of the frame body facing the metal back panel, and the mold frame is fixedly connected with the metal back panel via the magnetic layer.

In the backlight module according to the disclosure, the mold frame can be fixed to the metal back panel via the attractive force of the magnetic layer in such way that the mold frame is configured to include the frame body and the magnetic layer which is formed integrally with the frame body.

Thus, the backlight module according to the disclosure has better assembly stability and is more convenient to maintain.

In some optional embodiments, the frame body includes: a first border and a second border arranged parallel to each other, and a third border connected with a first end of the first border and a first end of the second border; where each of a second end of the first border and a second end of the second border is provided with a bended portion parallel to the third border.

In some optional embodiments, the magnetic layer is arranged at a connection of the first border and the third border, a connection of the first border and the bended portion, a connection of the second border and the third border, and a connection of the second border and the bended portion.

In some optional embodiments, the magnetic layer is at least arranged on the first border, the second border and the third border.

In some optional embodiments, at least parts of the magnetic layer which are located on the first border, the second border and the third border are a one-piece structure.

In some optional embodiments, the metal back panel includes: a base plate and a plurality of side plates, and the magnetic layer arranged on the frame body is located between the frame body and the plurality of side plates.

In some optional embodiments, the metal back panel includes: a base plate and a plurality of side plates, and the magnetic layer arranged on the frame body is located between the frame body and the base plate.

In some optional embodiments, the frame body is a plastic frame body.

The disclosure further provides a display device, which includes a display panel and the backlight module according to any one of the above embodiments.

The disclosure further provides a mold frame of a backlight module, which includes: a frame body and a magnetic layer molded on at least one surface of the frame body, where the mold frame is fixedly connected with a metal back panel via the magnetic layer.

### BRIEF DESCRIPTION OF THE DRAWINGS

FIG. 1 is a schematic structural diagram of a backlight module according to embodiments of the disclosure;

FIG. 2 is a schematic structural diagram of a mold frame according to the embodiments of the disclosure;

FIG. 3 is another schematic structural diagram of a mold frame according to the embodiments of the disclosure;

FIG. 4 is another schematic structural diagram of a backlight module according to the embodiments of the disclosure;

FIG. 5 is yet another schematic structural diagram of a mold frame according to the embodiments of the disclosure;

FIG. 6 is a schematic structural diagram of a display device according to the embodiments of the disclosure;

FIG. 7 is another schematic structural diagram of a display device according to the embodiments of the disclosure.

### DETAILED DESCRIPTION OF THE EMBODIMENTS

The technical solutions according to the embodiments of the disclosure will be described below clearly and fully with reference to the drawings in the embodiments of the disclosure. Obviously the embodiments described below are only a part but not all of the embodiments of the disclosure. Based upon the embodiments here of the disclosure, all the other embodiments obtained by those ordinary skilled in the art without any inventive effort shall fall into the scope of the disclosure.

As illustrated in FIG. 1, the disclosure provides a backlight module, which includes a metal back panel 1 and a mold frame 2 located at an inner side of the metal back panel 1, where the mold frame 2 includes: a frame body 21 and a magnetic layer 22 molded on at least one surface of a side of the frame body 21 facing the metal back panel 1, and the mold frame 2 is fixedly connected with the metal back panel 1 via the magnetic layer 22.

In the backlight module according to the disclosure, the mold frame 2 can be fixed to the metal back panel 1 via the attractive force of the magnetic layer 22 in such way that the mold frame 2 is configured to include the frame body 21 and the magnetic layer 22 which is formed integrally with the frame body 21, so that the occurrence of the badness such as stuck scrap, defective gum, poor assembly or the like between the mold frame 2 and the metal back panel 1 can be avoided, and simultaneously the occurrence of the separation phenomenon of the mold frame 2 and the metal back panel 1 due to the damage of the mold frame 2, the assembly misalignment or deformation or other conditions can be avoided, and it is not easy to cause the scrapping of the mold frame 2 and back panel 1 in the maintenance and rework process.

Thus, the backlight module according to the disclosure has better assembly stability and is more convenient to maintain.

Particularly, besides the metal back panel 1 and mold frame 2 as mentioned above, the backlight module further includes a reflection layer 5, a light guide plate 3, an optical film layer 4 and the like.

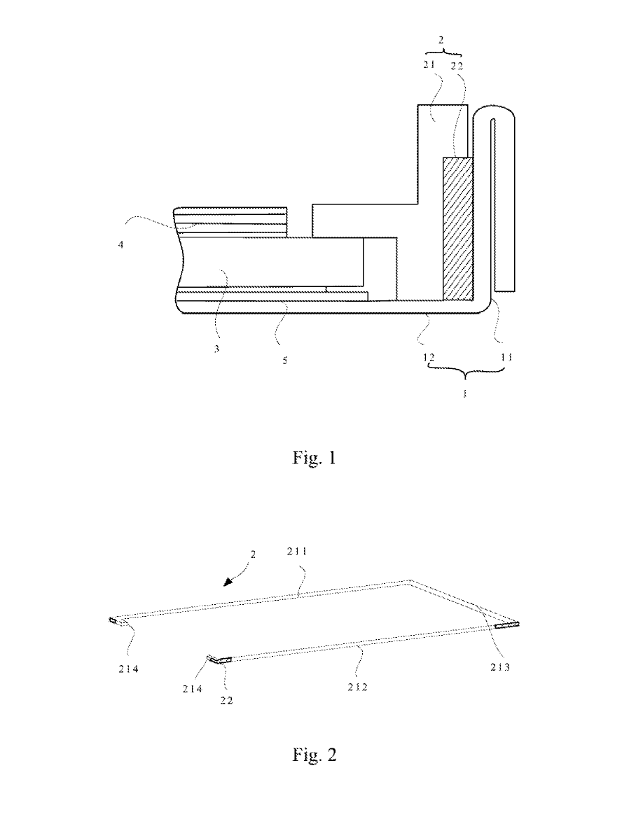

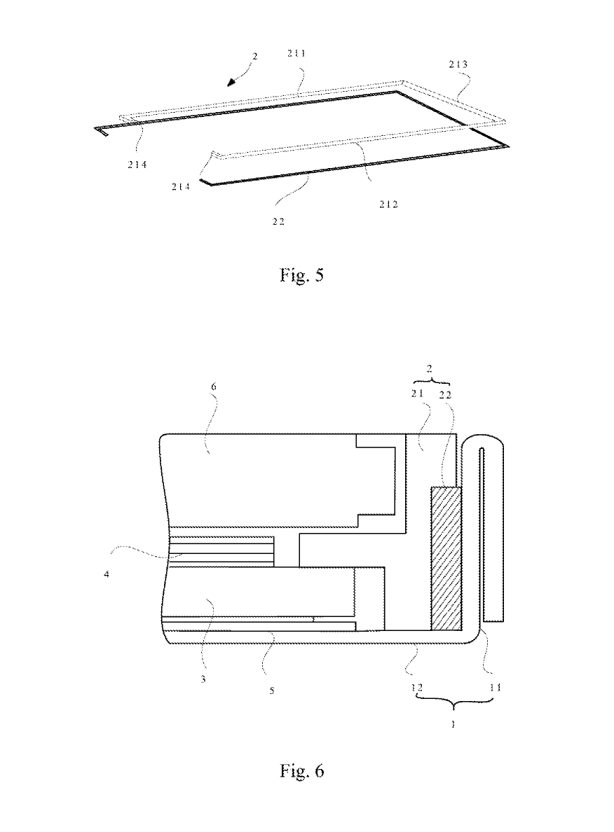

As illustrated in FIG. 2, FIG. 3 and FIG. 5, in order to facilitate the installation of the light source, the above frame body 21 includes: a first border 211 and a second border 212 arranged parallel to each other, and a third border 213 connected with a first end of the first border 211 and a first end of the second border 212, and each of a second end of the first border 211 and a second end of the second border 212 is provided with a bended portion 214 parallel to the third border 213.

Optionally, the magnetic layer 22 according to the disclosure can be a magnet, and the above mold frame 2 can be formed by an injection molding process of integrated iron and plastic.

Particularly, there can be several arrangement positions of the above magnetic layer 22.

In an optional embodiment, as illustrated in FIG. 2, the magnetic layer 22 is arranged at a connection of the first border 211 and the third border 213, a connection of the first border 211 and the bended portion 214, a connection of the second border 212 and the third border 213, and a connection of the second border 212 and the bended portion 214. Such structural arrangement can save the materials on one hand, and increase the fixation stability between the mold frame 2 and the metal back panel 1 on the other hand.

In another optional embodiment, the magnetic layer 22 is at least arranged on the first border 211, the second border 212 and the third border 213. That is, as illustrated in FIG. 3, the magnetic layer 22 can be arranged on the first border 211, the second border 212 and the third border 213, or as illustrated in FIG. 5, the magnetic layer 22 is arranged on the first border 211, the second border 212, the third border 213 and the bended portion 214.

Optionally, in order to facilitate the preparation of the magnetic layer 22, at least the parts of the magnetic layer 22 which are located on the first border 211, the second border 212 and the third border 213 are a one-piece structure. That is, in a type of structure: if the magnetic layer 22 is only located on the first border 211, the second border 212 and the third border 213, the parts of the magnetic layer 22 which are located on the first border 211, the second border 212 and the third border 213 are a one-piece structure; in another type of structure: if the magnetic layer 22 is located on the first border 211, the second border 212, the third border 213 and the bended portion 214, only the parts of the magnetic layer 22 which are located on the first border 211, the second border 212 and the third border 213 are a one-piece structure; and in yet another type of structure: if the magnetic layer 22 is located on the first border 211, the second border 212, the third border 213 and the bended portion 214, the parts of the magnetic layer 22 which are located on the first border 211, the second border 212, the third border 213 and the bended portion 214 are a one-piece structure.

Particularly, the surfaces of the first border 211, the second border 212, the third border 213 and the bended portion 214 on which the magnetic layer 22 is arranged can be set by those skilled in the art according to the actual requirements.

Optionally, as illustrated in FIG. 1, FIG. 2 and FIG. 3, the metal back panel 1 includes: a base plate 12 and a plurality of side plates 11, and the magnetic layer 22 arranged on the frame body 21 is located between the frame body 21 and the plurality of side plates 11. In such arrangement manner, the fixation is firmer.

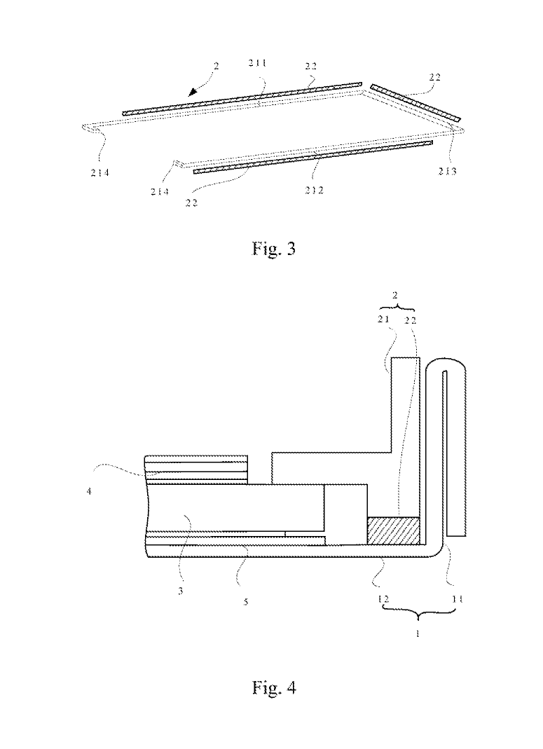

Optionally, as illustrated in FIG. 4 and FIG. 5, the metal back panel 1 includes: a base plate 12 and a plurality of side plates 11, and the magnetic layer 22 arranged on the frame body 21 is located between the frame body 21 and the base plate 12. In such arrangement manner, the mold frame 2 is fixed more firmly along a direction perpendicular to the base plate 12, but it is easy for the mold frame 2 to generate a displacement along a direction perpendicular to the side plates 11.

There can be several types of materials of the above frame body 21. Optionally, in order to reduce the attrition of the light guide plate 3, the optical film layer 4 and the reflection layer 5, the frame body 21 can be made from the plastic material.

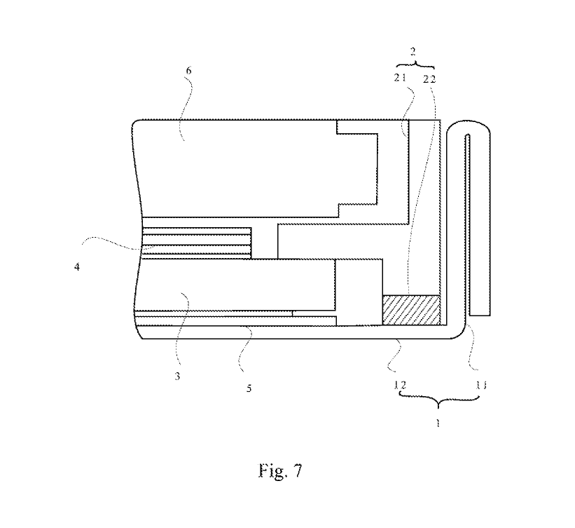

As illustrated in FIG. 6 and FIG. 7, the disclosure further provides a display device, which includes a display panel 6 and the backlight module according to any one of the above embodiments.

Particularly, the above backlight module includes a metal back panel 1, a mold frame 2, a reflection layer 5, a light guide plate 3, an optical film layer 4 and other structures; where the mold frame 2 includes a frame body 21 and a magnetic layer 22 which is molded on the frame body 21, and the mold frame 2 is fixedly connected with the metal back panel 1 via the magnetic attraction force of the magnetic layer 22. Optionally, as illustrated in FIG. 6, the magnetic layer 22 can be arranged between the frame body 21 and a plurality of side plates 11 of the metal back panel 1; or as illustrated in FIG. 7, the magnetic layer 22 can be arranged between the frame body 21 and the base plate 12 of the metal back panel 1.

In the above backlight module, the mold frame 2 is fixedly connected with the metal back panel 1 via the magnetic layer 22 and has better assembly stability, so the display device according to the disclosure has better stability and a longer service life.

Particularly, the display device according to the embodiments of the disclosure can be any one of a mobile phone, a tablet computer, an electronic paper and an electronic photo frame.

As illustrated in FIG. 2, FIG. 3 and FIG. 5, the disclosure further provides a mold frame 2 of a backlight module, which includes: a frame body 21 and a magnetic layer 22 which is molded on at least one surface of the frame body 21, and as illustrated in FIG. 1 and FIG. 4, the mold frame 2 can be fixedly connected with the metal back panel 1 via the magnetic layer 22.

Particularly, the embodiments of the mold frame provided by the disclosure can be the same as the embodiments of the mold frame in the backlight module of the disclosure, and furthermore, the embodiments of the positional relationship between the mold frame provided by the disclosure and the metal back panel in the backlight module can be the same as the embodiments of the positional relationship between the mold frame and the metal back panel in the backlight module of the disclosure.

As illustrated in FIG. 2, FIG. 3 and FIG. 5, in order to facilitate the installation of the light source, the frame body 21 includes: a first border 211 and a second border 212 arranged parallel to each other, and a third border 213 connected with a first end of the first border 211 and a first end of the second border 212, and each of a second end of the first border 211 and a second end of the second border 212 is provided with a bended portion 214 parallel to the third border 213.

Optionally, the magnetic layer 22 according to the disclosure can be a magnet, and the above mold frame 2 can be formed by an injection molding process of integrated iron and plastic.

Particularly, there can be several arrangement positions of the above magnetic layer 22.

In an optional embodiment, as illustrated in FIG. 2, the magnetic layer 22 is arranged at a connection of the first border 211 and the third border 213, a connection of the first border 211 and the bended portion 214, a connection of the second border 212 and the third border 213, and a connection of the second border 212 and the bended portion 214. Such structural arrangement can save the materials on one hand, and increase the fixation stability between the mold frame 2 and the metal back panel 1 on the other hand.

In another optional embodiment, the magnetic layer 22 is at least arranged on the first border 211, the second border 212 and the third border 213. That is, as illustrated in FIG. 3, the magnetic layer 22 can be arranged on the first border 211, the second border 212 and the third border 213, or as illustrated in FIG. 5, the magnetic layer 22 is arranged on the first border 211, the second border 212, the third border 213 and the bended portion 214.

Optionally, in order to facilitate the preparation of the magnetic layer 22, at least the parts of the magnetic layer 22 which are located on the first border 211, the second border 212 and the third border 213 are a one-piece structure. That is, in a type of structure: if the magnetic layer 22 is only located on the first border 211, the second border 212 and the third border 213, the parts of the magnetic layer 22 which are located on the first border 211, the second border 212 and the third border 213 are a one-piece structure; in another type of structure: if the magnetic layer 22 is located on the first border 211, the second border 212, the third border 213 and the bended portion 214, only the parts of the magnetic layer 22 which are located on the first border 211, the second border 212 and the third border 213 are a one-piece structure; and in yet another type of structure: if the magnetic layer 22 is located on the first border 211, the second border 212, the third border 213 and the bended portion 214, the parts of the magnetic layer 22 which are located on the first border 211, the second border 212, the third border 213 and the bended portion 214 are a one-piece structure.

Particularly, the surfaces of the first border 211, the second border 212, the third border 213 and the bended portion 214 on which the above magnetic layer 22 is arranged can be set by those skilled in the art according to the actual requirements.

Optionally, as illustrated in FIG. 1, FIG. 2 and FIG. 3, the metal back panel 1 includes: a base plate 12 and a plurality of side plates 11, and the magnetic layer 22 arranged on the frame body 21 is located between the frame body 21 and the plurality of side plates 11. In such arrangement manner, the fixation is firmer.

Optionally, as illustrated in FIG. 4 and FIG. 5, the metal back panel 1 includes: a base plate 12 and a plurality of side plates 11, and the magnetic layer 22 arranged on the frame body 21 is located between the frame body 21 and the base plate 12. In such arrangement manner, the mold frame 2 is fixed more firmly along a direction perpendicular to the base plate 12, but it is easy for the mold frame 2 to generate a displacement along a direction perpendicular to the side plates 11.

There can be several types of materials of the above frame body 21. Optionally, in order to reduce the attrition of the light guide plate 3, the optical film layer 4 and the reflection layer 5, the frame body 21 can be made from the plastic material.

Evidently those skilled in the art can make various modifications and variations to the disclosure without departing from the spirit and scope of the disclosure. Thus the disclosure is also intended to encompass these modifications and variations to the disclosure as long as these modifications and variations come into the scope of the claims of the disclosure and their equivalents.

1. A backlight module, comprising:
a metal back panel; and
a mold frame located at an inner side of the metal back panel;
wherein the mold frame comprises a frame body and a magnetic layer molded on at least one surface of a side of the frame body facing the metal back panel, and the mold frame is fixedly connected with the metal back panel via the magnetic layer.

2. The backlight module according to claim 1, wherein the frame body comprises: a first border and a second border arranged parallel to each other, and a third border connected with a first end of the first border and a first end of the second border; wherein each of a second end of the first border and a second end of the second border is provided with a bended portion parallel to the third border.

3. The backlight module according to claim 2, wherein the magnetic layer is arranged at a connection of the first border and the third border, a connection of the first border and the bended portion, a connection of the second border and the third border and a connection of the second border and the bended portion.

4. The backlight module according to claim 2, wherein the magnetic layer is at least arranged on the first border, the second border and the third border.

5. The backlight module according to claim 4, wherein at least parts of the magnetic layer which are located on the first border, the second border and the third border are a one-piece structure.

6. The backlight module according to claim 1, wherein the metal back panel comprises: a base plate and a plurality of side plates; and the magnetic layer arranged on the frame body is located between the frame body and the plurality of side plates.

7. The backlight module according to claim 1, wherein the metal back panel comprises: a base plate and a plurality of side plates; and the magnetic layer arranged on the frame body is located between the frame body and the base plate.

8. The backlight module according to claim 1, wherein the frame body is a plastic frame body.

9. A display device, comprising a display panel and a backlight module; wherein the backlight module comprises:
a metal back panel; and
a mold frame located at an inner side of the metal back panel;
wherein the mold frame comprises a frame body and a magnetic layer molded on at least one surface of a side of the frame body facing the metal back panel, and the mold frame is fixedly connected with the metal back panel via the magnetic layer.

10. A mold frame of a backlight module, comprising: a frame body and a magnetic layer molded on at least one surface of the frame body, wherein the mold frame is fixedly connected with a metal back panel via the magnetic layer.

11. The mold frame according to claim 10, wherein the frame body comprises: a first border and a second border arranged parallel to each other, and a third border connected with a first end of the first border and a first end of the second border; wherein each of a second end of the first border and a second end of the second border is provided with a bended portion parallel to the third border.

12. The mold frame according to claim 11, wherein:
the magnetic layer is arranged at a connection of the first border and the third border, a connection of the first border and the bended portion, a connection of the second border and the third border and a connection of the second border and the bended portion; or
the magnetic layer is at least arranged on the first border, the second border and the third border.

13. The mold frame according to claim 10, wherein:
the metal back panel comprises: a base plate and a plurality of side plates; and
the magnetic layer arranged on the frame body is located between the frame body and the plurality of side plates; or the magnetic layer arranged on the frame body is located between the frame body and the base plate.

14. The display device according to claim 9, wherein the frame body comprises: a first border and a second border arranged parallel to each other, and a third border connected with a first end of the first border and a first end of the second border; wherein each of a second end of the first border and a second end of the second border is provided with a bended portion parallel to the third border.

15. The display device according to claim 14, wherein the magnetic layer is arranged at a connection of the first border and the third border, a connection of the first border and the bended portion, a connection of the second border and the third border and a connection of the second border and the bended portion.

16. The display device according to claim 14, wherein the magnetic layer is at least arranged on the first border, the second border and the third border.

17. The display device according to claim 16, wherein at least parts of the magnetic layer which are located on the first border, the second border and the third border are a one-piece structure.

18. The display device according to claim 9, wherein the metal back panel comprises: a base plate and a plurality of side plates; and the magnetic layer arranged on the frame body is located between the frame body and the plurality of side plates.

19. The display device according to claim 9, wherein the metal back panel comprises: a base plate and a plurality of side plates; and the magnetic layer arranged on the frame body is located between the frame body and the base plate.

20. The display device according to claim 9, wherein the frame body is a plastic frame body.
